(19) United States
(12) Patent Application Publication
(10) Pub. No.: US 2025/0104307 A1
(43) Pub. Date: Mar. 27, 2025

(54) LIVE WEB-BASED SPECIAL EFFECTS

(71) Applicant: Snap Inc., Santa Monica, CA (US)

(72) Inventors: Michael James Connolly, Mill Valley, CA (US); Xuelun Fu, London (GB); Christine Hasrouni, Los Angeles, CA (US); David Phillip Taitz, Los Angeles, CA (US)

(21) Appl. No.: 18/631,354

(22) Filed: Apr. 10, 2024

Related U.S. Application Data
(60) Provisional application No. 63/584,284, filed on Sep. 21, 2023.

(51) Int. Cl. G06T 11/60; G06T 19/00

(52) U.S. Cl. CPC G06T 11/60; G06T 19/006

(57) ABSTRACT

A system and method for enabling augmented reality effects in a web browser without requiring installation of additional software is disclosed. A web server provides a website with a gallery of selectable special effects. Upon selecting an effect, the website loads a page specific to that effect which includes a live preview showing the effect applied to a video feed from the user's webcam. This allows the user to view themselves with the effect applied in real-time. The website requests access to the webcam and microphone through the browser's built-in permission system. Captured photos and videos with the effect applied can be saved locally or shared through native operating system tools. The system provides an engaging augmented reality experience accessible directly via a standard web browser, without needing to install a dedicated app.

### RELATED APPLICATIONS

This application claims the benefit of and priority to U.S. Provisional Patent Application No. 63/584,284, filed on Sep. 21, 2023, the entire contents of which are incorporated herein by reference.

### TECHNICAL FIELD

Embodiments of the present invention relate to techniques for providing special effects-specifically, augmented reality effects-in a web browser environment, wherein an augmented reality effect includes real-time manipulation of images captured by an image sensor of a user's computing device according to a special effect selected by an end-user, presented within a web page without requiring installation of a software application.

### BACKGROUND

Client software applications, including both mobile applications designed for smartphones and tablets as well as desktop applications designed for personal computers, allow users to access online services and generate engaging content through the various input and output capabilities of their devices. For example, these client applications are typically programmed specifically for the operating system of the device on which they are installed, and leverage application programming interfaces (APIs) and other techniques to gain access to hardware resources, such as a built-in camera, microphone, touchscreen, etc. This allows the client applications to create images, videos, and other media enhanced by special effects and augmented reality experiences.

However, the web and desktop versions of these same online services, which are accessed via a web browser rather than a dedicated application, often have limited functionality compared to their client application counterparts. When people first discover a service through a web browser, they may not experience the full range of features available in the client application. This can make it difficult for online services to attract and engage new users through web browsers.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which embodiments of the innovative subject matter may be deployed, according to some examples.

FIG. 2 is a diagrammatic representation of a messaging system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 is a flow diagram illustrating method operations for presenting a live view of a special effect via a web page, according to some examples.

FIG. 6 is a user interface diagram, according to some examples.

FIG. 7 is a user interface diagram, according to some examples.

FIG. 8 is a user interface diagram according to some examples.

FIG. 9 is a user interface diagram, according to some examples.

FIG. 10 is a user interface diagram, according to some examples.

FIG. 11 is a user interface diagram, according to some examples.

FIG. 12 is a user interface diagram, according to some examples.

FIG. 13 is diagrammatic representation of a machine in the form of a computer system within which a set of instructions may be executed to cause the machine to perform any one or more of the methodologies discussed herein, according to some examples.

FIG. 14 is a block diagram showing a software architecture within which examples may be implemented.

### DETAILED DESCRIPTION

Described herein are methods, systems, and computer program products, for enabling special effects, including augmented reality effects, to be experienced directly within a web browser without requiring installation of any additional software. A web page provides selections of special effects which can be applied in real-time to live video captured by the device's camera and displayed back to the user via the browser. There is no need for the user to download and install a separate application or register as a member of the service to access and try out the available special effects. Captured photos and videos incorporating the special effects can then be saved and shared using native operating system capabilities, providing an engaging augmented reality experience through standard web technology. In the following description, for purposes of explanation, numerous specific details are set forth to provide a thorough understanding of the various aspects of different embodiments of the present invention. It will be evident, however, to one skilled in the art, that the present invention may be practiced without all of these specific details.

Many popular online services and social media platforms offer special effects, such as augmented reality experiences, through dedicated mobile applications (apps). These apps are installed on the end-user's smartphone or tablet and leverage the client device's camera, microphone, and other hardware capabilities. By accessing native application programming interfaces (APIs) and frameworks, the apps can apply graphics, animations, and other enhancements as filters and overlays to photos and videos captured by the end-user. For example, a mobile app may provide various selfie special effects that alter or animate portions of the user's face in real-time using the front-facing camera.

While these mobile apps provide engaging experiences, a major downside is that users first have to locate, download, and install the mobile app before gaining access to the special effects. This friction means that some users will never discover the mobile app or will abandon the download process before installation. Even for installed apps, users may not take time to explore features like special effects if they are not easily discoverable. Additionally, mobile apps often require creating an account and going through a registration process before unlocking full functionality. Together, these hurdles limit an app's ability to attract and delight new users. Web experiences accessible directly from a browser offer much lower friction for users to explore new apps and features.

Furthermore, the requirement to install an app and register as an end-user or member creates challenges when existing users want to share a particular effect with friends or contacts, who are not registered end-users of the online service. For example, if a registered end-user or member finds an entertaining or amusing special effect in the mobile app and wants to share it with a friend who is not a member (e.g., a registered end-user) of the online service, there is no easy way for the non-member to try the effect without first downloading the app and creating an account. This severely limits the ability for members to virally spread awareness of a special effect.

Embodiments of the present invention address the aforementioned technical problems by allowing non-members (e.g., unregistered end-users) of an online service to experience special effects, including augmented reality effects and experiences, directly in a web browser without needing to install software, create an account or register. A web server hosts a website that provides a catalog or gallery of special effects that can be previewed by any visitor. When a user selects a particular effect, the website loads a page specific to that effect. This page includes a live preview window that shows a video feed from the user's webcam along with the selected effect applied in real-time. Accordingly, the user can view and test various special effects.

One advantage over conventional online services is that users can immediately try out and experiment with special effects, without friction. There is no mobile or desktop app to find, download, install, and there is no requirement to become a registered end-user. Each special effect works directly in the web browser leveraging standardized web technology like HTML5, JavaScript, and WebRTC. The web server provides all necessary code to access the webcam stream and render graphics/animations as overlays on the live video.

Consistent with some embodiments, to enable special effects to be applied, the website requests access to the user's camera and microphone using the browser permission system. Once granted, all video processing and audio processing occurs locally in the browser. At least with some embodiments, media streams are not sent to the server. This maintains user privacy while providing engaging special effects. After previewing a particular special effect, the user can capture a still image (e.g., a photo) and record video clips incorporating the special effect through browser APIs.

Captured photos and videos can then be saved locally or shared via native operating system (OS) sharing tools. For example, on a smartphone, the user could save to camera roll or share via messaging apps. Alternatively, if the user has a registered account, photos/videos captured via the web browser can be saved and shared within the web-based experience itself. Furthermore, in some instances, if a user is a member or registered end-user, after capturing a media content item (e.g., an image or video clip), the user may authenticate with the online service to share the captured content item via the app experience.

By removing the barriers associated with the traditional in-app experience, like complex installation and mandatory end-user registration, embodiments make the special effects more discoverable and shareable to everyday users. Web technology allows users to enjoy special effects directly in their browser without being locked into a specific app ecosystem. Other aspects, features and advantages arising from the disclosed methods and systems will become more apparent upon reading the description of the several figures that follow.

### Networked Computing Environment

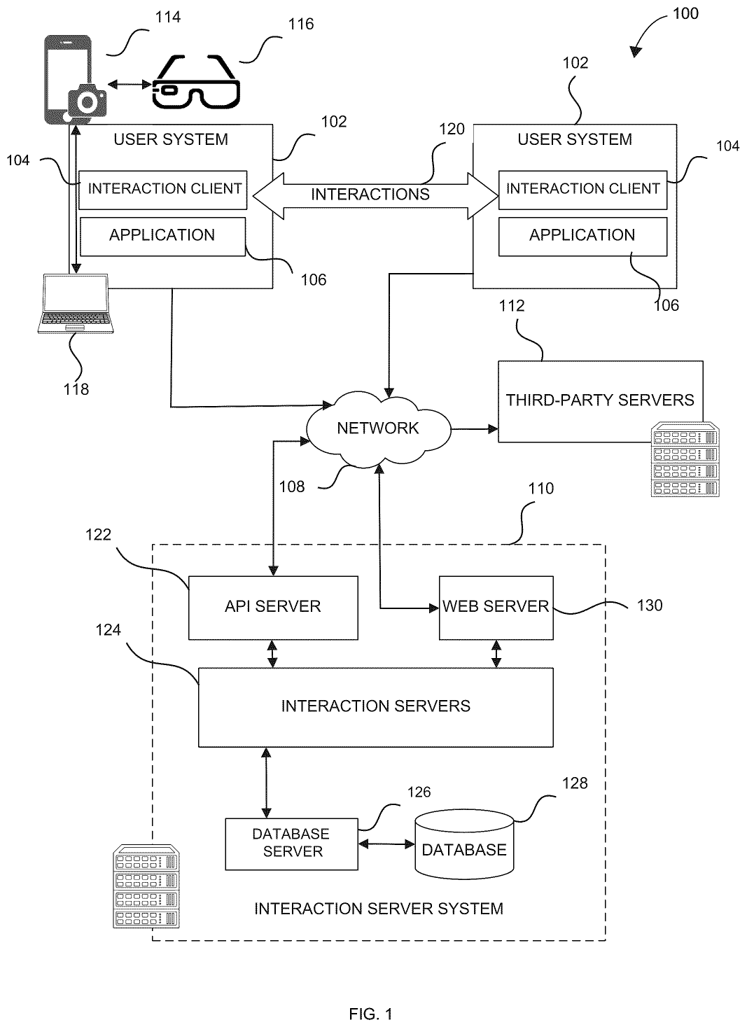

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include a native application, such as the interaction client, that is customized for that device's operating system, such as a mobile app on a smartphone or tablet. This mobile app can provide a mechanism for the user system to communicate with the interaction servers hosted on the interaction server system 110. For example, the interaction client 104, and associated application 106 may handle capturing images and streaming them to the interaction servers 124, via API server 122, for processing augmented reality effects. However, consistent with some embodiments, each user system 104 may use a conventional web browser application to access the various features provided by the interaction servers 124, without requiring installing any native apps on the user system 102. Accordingly, the functionality of the interaction servers (e.g., the augmented reality effects and services) can be accessed directly via a standard web browser application 106 using common web protocols like HTTP, WebRTC, and JavaScript. This allows casual users to quickly try out fun effects without needing to locate, download, install, create an account for, and learn how to use a new native app first. The web browser application 104 can access device components of the user system, like the camera, through APIs and process effects right in the browser application, allowing users to enjoy engaging augmented reality experiences entirely through open web standards.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Programming Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104).

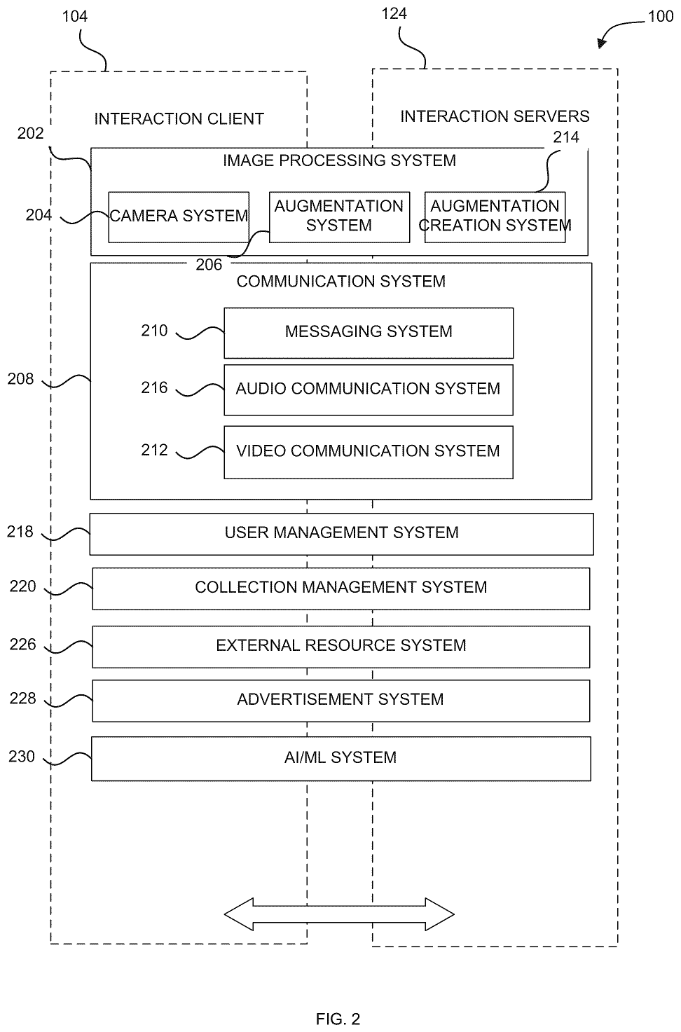

The interaction servers 124 host multiple systems and subsystems, described below with reference to FIG. 2.

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of special effects, including augmentations (e.g., media overlays) for images captured in real-time by cameras of the user system 102 or retrieved from memory of the user system 102. For example, the augmentation system 206 operatively selects, presents, and displays media overlays (e.g., an image filter or special effect) to the interaction client 104 for the augmentation of real-time images received via the camera system 204 or stored images retrieved from memory 502 of a user system 102. These special effects or augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image, video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

### Data Architecture

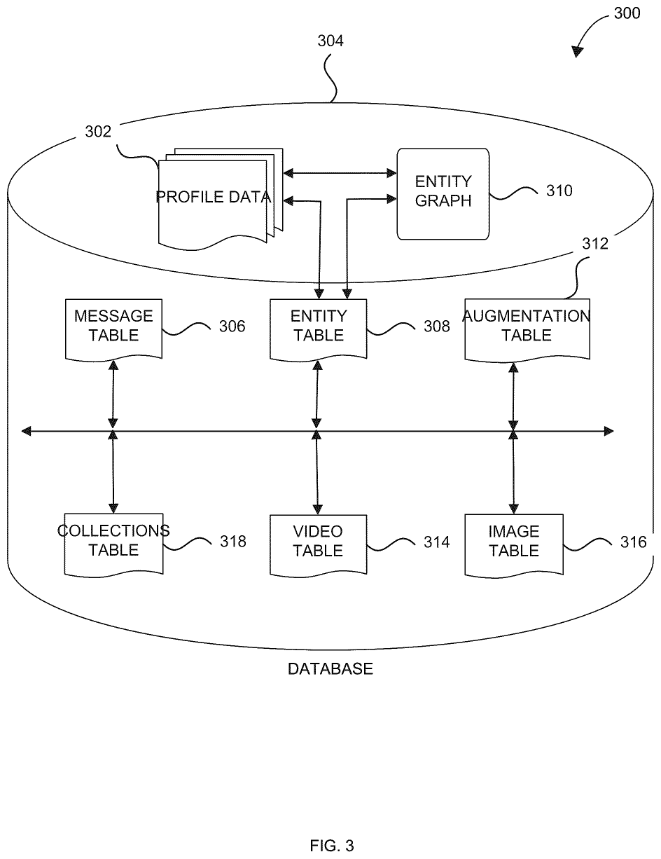

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Data Communications Architecture

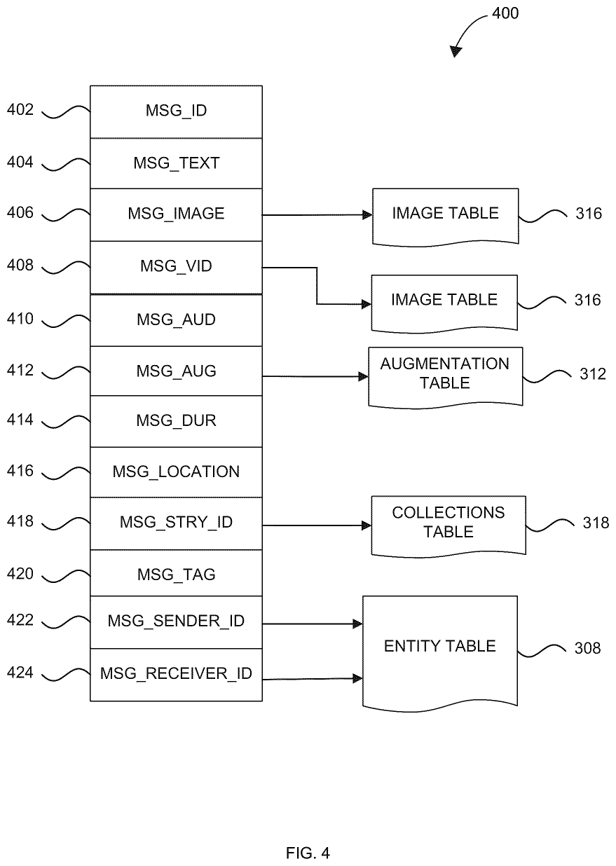

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the collections table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a collections table 318, and values stored within the message sender identifier 422 and the message receiver identifier 424 may point to user records stored within an entity table 308.

### Web Browser Experience

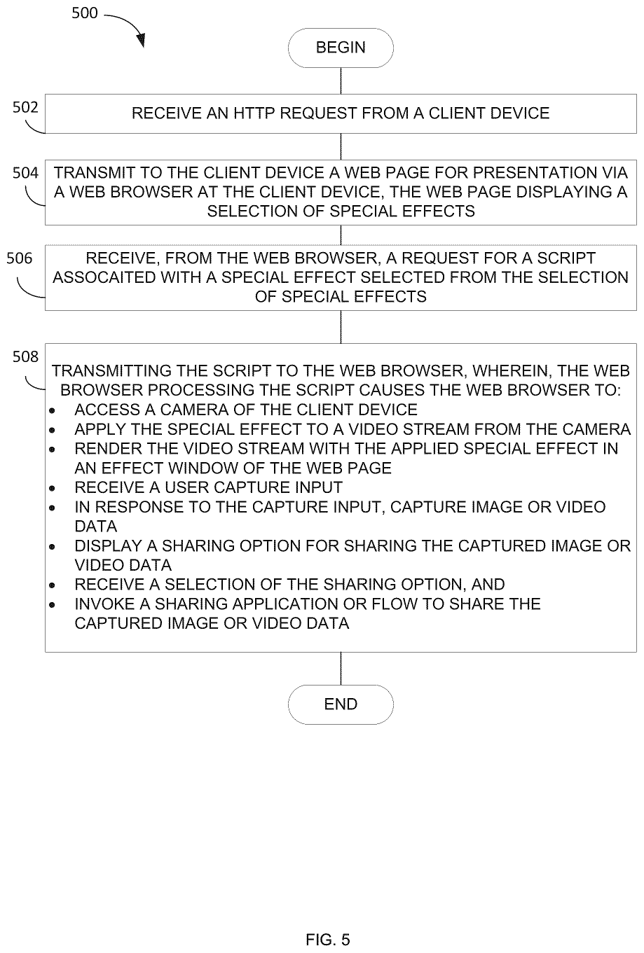

FIG. 5 is a flow diagram illustrating method operations for presenting a live view of a special effect via a web page, according to some examples. The process begins when a user, using a web browser application, invokes an HTTP request for a web page hosted by a web server providing a special effects service. Accordingly, at operation 502, the web server receives the HTTP request from the web browser. At operation 504, the web server responds to the web browser by transmitting to the web browser data representing a web page, where the web page, when presented by the web browser, will display a selection of special effects. In this case, each special effect may be associated with code, hosted by the server, for causing the web browser to render the special effect.

Next, at operation 506, the web server receives from the web browser a request for a specific special effect, for example, as a result of the user selecting one special effect from the selection of special effects presented to the user. At operation 508, the web server responds by transmitting to the web browser, computer code (e.g., a script), which, when processed by the web browser, will cause the web browser to perform various operations to render the special effect. For example, when the web browser processes the script received from the web server, the web browser will access the camera of the client device to obtain a video stream from the camera. The web browser will then apply the special effect, per the instruction specified in the script, to the live video stream, resulting in the rendering of a live view in an effect window of the web page presented by the web browser. The web browser will also presented a button or other GUI element, that, when selected, will cause a media content item to be captured—e.g., a still image or video clip, to which the special effect has been applied. The web browser will also present one or more buttons or GUI elements, with which the user may interact to save or share the media content item. Further description and explanation of these options are described below in connection with the description of the several figures illustrating example user interfaces.

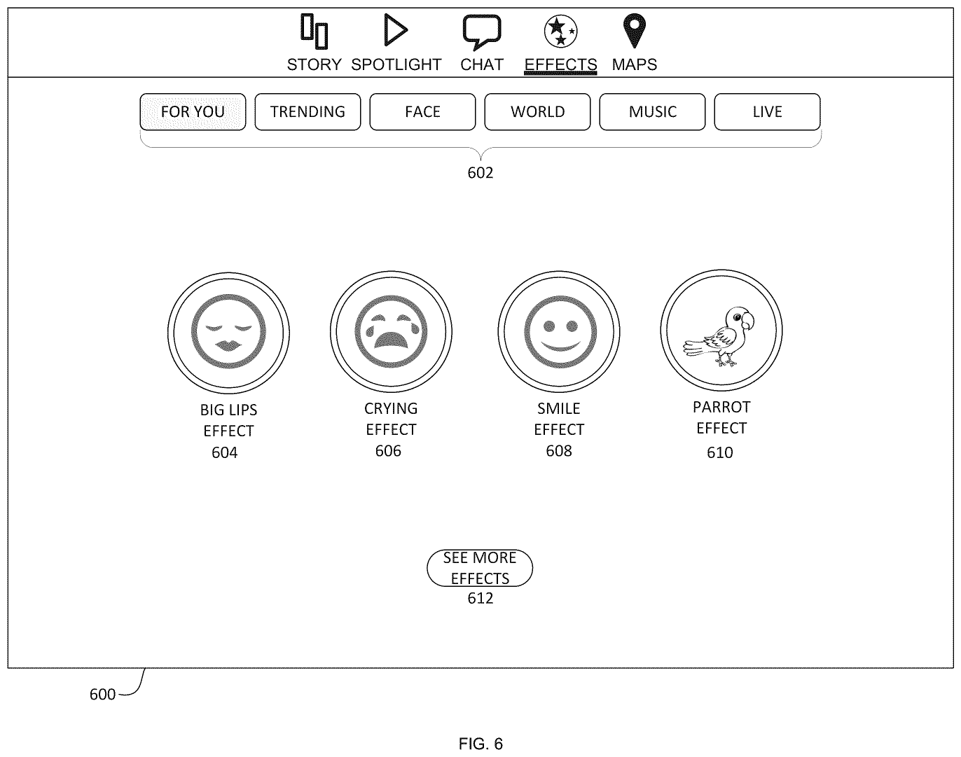

FIG. 6 is a user interface diagram illustrating an example of a web page (e.g., a landing page) 600 for selecting special effects, consistent with some embodiments. The web page 600 shows several filtering or selection criteria 602, including options labeled as, “For You”, “Trending”, “Face”, “World”, “Music”, and “Live”. These categories and selection criteria 602 allow the user to browse special effects tailored to their interests, see popular effects, find special effects for augmenting faces or environments, and explore special effects with music, or live effects. For example, by selecting a specific GUI element (e.g., button), the available special effects are selected or filtered by selection criteria associated with the button, and then the selected special effects are presented to the user via the web page 600.

In addition, several user-selectable graphics are displayed, where each graphic represents a different special effect that can be previewed: “Big Lips” 604, “Crying” 606, “Smile” 608, and “Parrot” 610. Finally, a button labeled, “See More Effects” 612, is shown that, when selected, will cause additional special effects options to be presented to the user.

This landing page 600 provides an intuitive and engaging way for users to explore the library of special effects available through the web interface. Effects are organized into logical categories to fit various use cases. The user can tap on any effect thumbnail or graphic to view a demo and try it with their live camera feed. Additional effects are just a tap or mouse click away. This makes discovering fun effects highly accessible for casual users directly through their web browser, without needing to install any additional software.

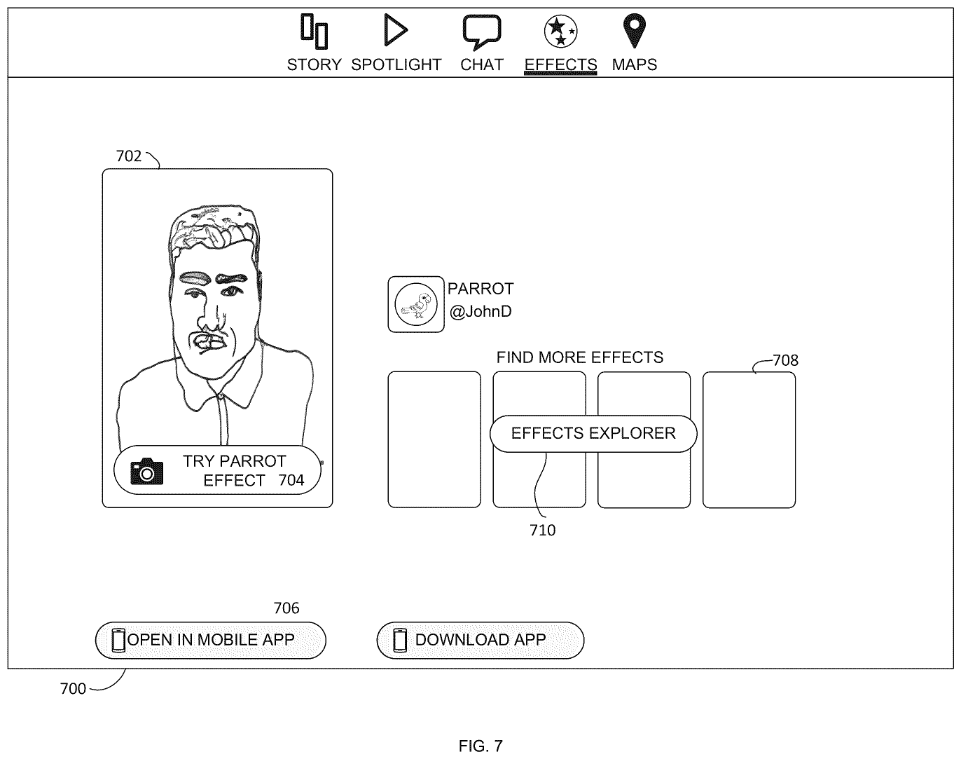

FIG. 7 illustrates a user interface diagram showing a web page 700 for a specific special effect. When the web page 700 is first presented, an animation may be displayed in the effect window 702 showing an example of the special effect in action. A button labeled “Try Parrot Effect” 704 is displayed, which when selected, will invoke a process to allow the user to see a live view of the special effect applied to images captured in real-time from their device's camera.

The web page 700 also includes a button “Open In Mobile App” 706 which provides the user with the option to switch to an app-based experience if they have the native mobile application installed. A profile image and name “@JohnD” indicates an example social media user who has provided or published the special effect. A variety of additional special effects are presented along with a “Find More Effects” button 708 that, when selected, will allow the user to view additional special effects. With some embodiments, the additional special effects that are presented on any particular special effect page may be selected for presentation according to specific selection criteria. For example, the additional special effects may be related to the main special effect, for example, by virtue of frequently being selected by users who also select the main special effect (e.g., the parrot effect, in FIG. 7).

The special effect web page 700 allows the user to preview a specific effect (e.g., the “Parrot” effect), easily try it out live using their camera, and share the results through integrated social features. The options to open the effect in a mobile app or find more effects provide a seamless experience across platforms. The user can have fun with the Parrot effect entirely through their web browser, without needing to install any additional software or register for accounts.

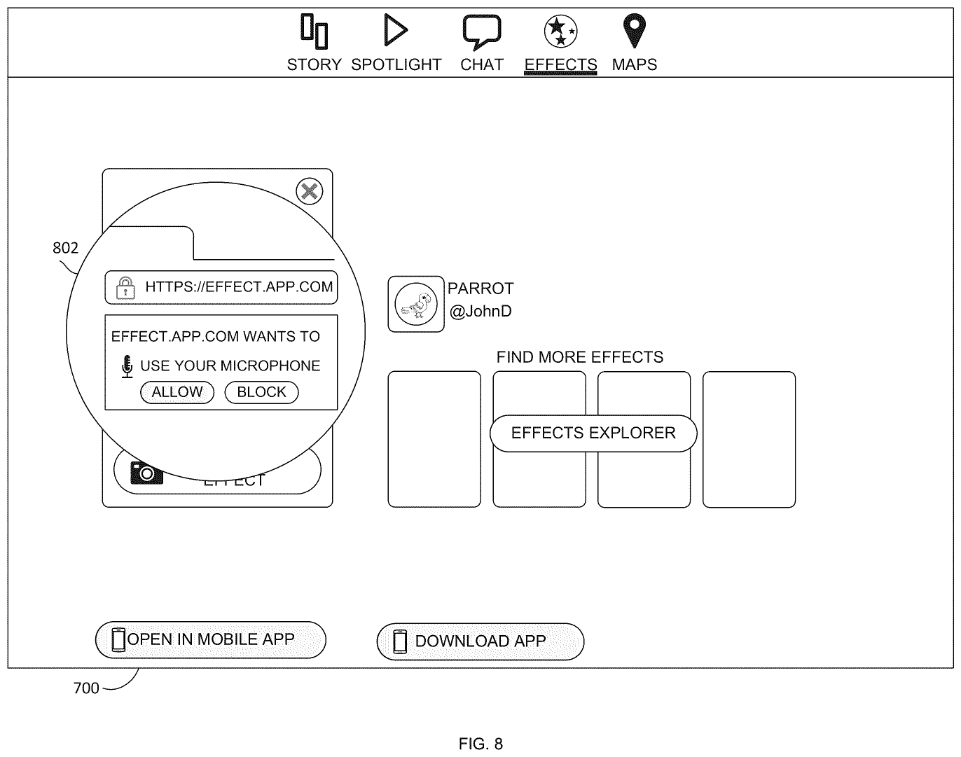

FIG. 8 illustrates an example of a browser dialog box 802 prompting the user to authorize access to their device's microphone. When the web page 700 attempts to access the microphone to enable a selected special effect, the web browser detects this and opens a dialog box. The dialog explains that “effect.app.com wants to use your microphone” and presents options to “Allow” or “Block” access.

This dialog box is provided by the underlying operating system and gives the user control over granting website access to protected hardware like the microphone. If the user selects “Allow”, the web page JavaScript code will get access to live audio input which can be processed and augmented based on the special effect. If the user selects “Block”, the website will be prevented from accessing the microphone.

Requesting this permission and authorization from the user provides important privacy and security protections. The user is informed about what data the web page seeks to access and can choose to allow or deny access accordingly. The browser and operating system mediate and control access to hardware components like the microphone, rather than unconditionally granting website access.

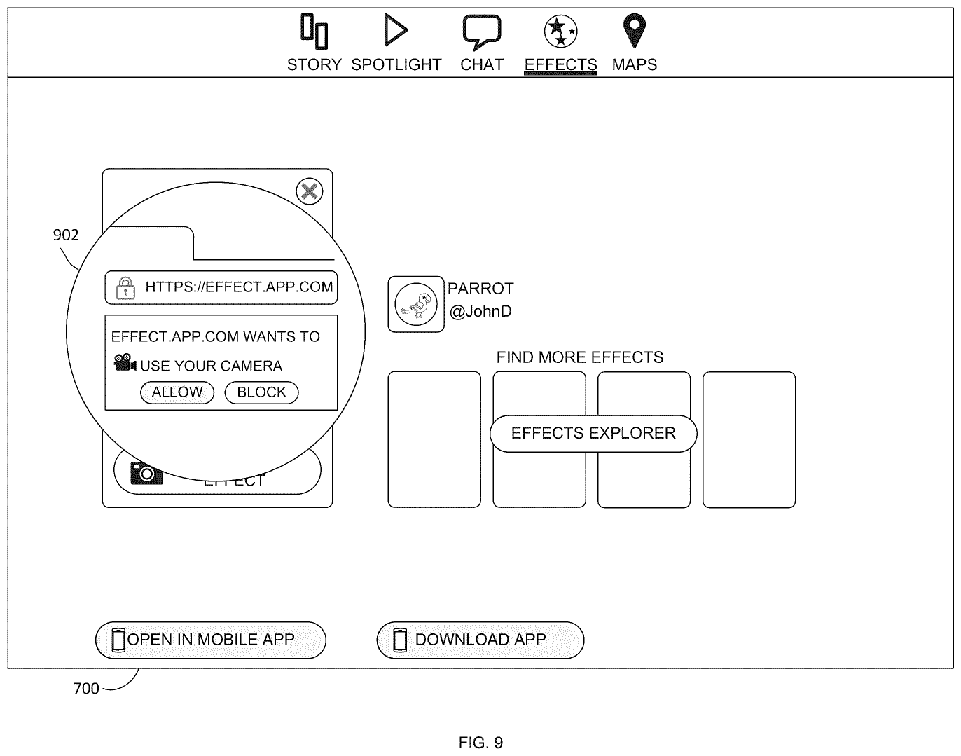

FIG. 9 illustrates an example of a browser dialog box 902 prompting the user to authorize access to their device's camera. When the web page 700 attempts to access the camera to enable a selected special effect, the browser detects this and opens the dialog box 902. The dialog explains 902 that “effect.app.com wants to use your camera” and presents options to “Allow” or “Block” access.

This dialog box 902 is provided by the underlying operating system and gives the user control over granting website access to protected hardware like the camera. If the user selects “Allow”, the web page JavaScript code will get access to live video input which can be processed and augmented based on the effect. If the user selects “Block”, the website will be prevented from accessing the camera.

Requesting this permission and authorization from the user provides important privacy and security protections. The user is informed about what data the web page seeks to access and can choose to allow or deny access accordingly. The browser and operating system mediate and control access to hardware components like the camera, rather than unconditionally granting website access.

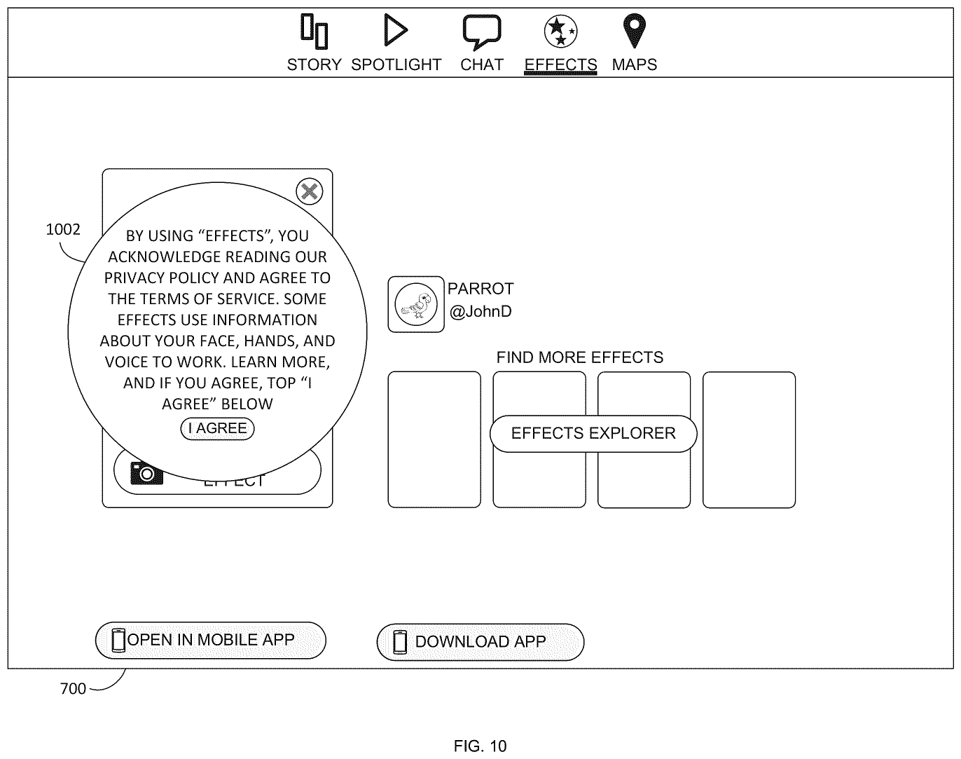

FIG. 10 illustrates an example of a dialog box 1002 prompting the user to agree to terms of service and privacy policies before accessing the special effects. The dialog box 1002 states that “By using ‘Effects’, you acknowledge reading our privacy policy and agree to the terms of service.” It further explains that “Some effects use information about your face, hands, and voice to work.”

The dialog box 1002 prompts the user to learn more, and if they agree, to tap the “I Agree” button to continue. This ensures the user understands how their biometric data may be used and provides explicit opt-in consent. Requesting this acknowledgement and agreement to policies provides transparency around data usage and collection. The user is informed about how special effects utilize personal information like facial and voice data. The system obtains clear consent from the user before accessing any biometrics or sensitive user data. This promotes user awareness and trust in the privacy practices of the effects web service.

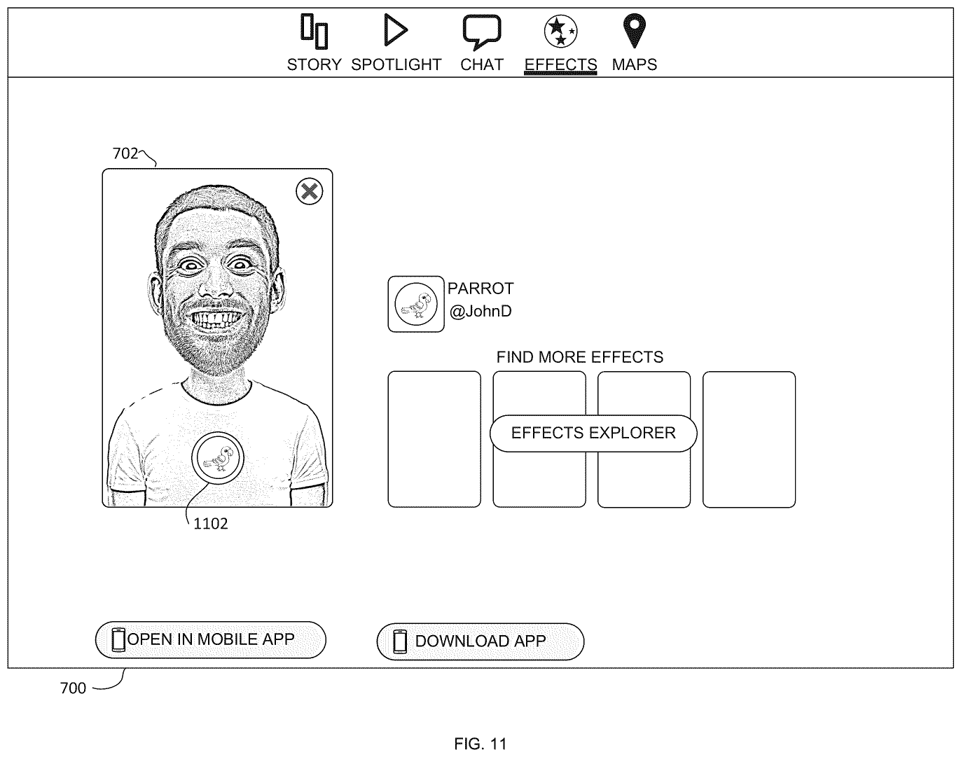

FIG. 11 illustrates an example of the live view in the effect window 702 showing the special effect applied to the camera feed in real-time. This provides the user with a preview of the special effect on themselves, allowing them to see how it will augment their appearance before capturing photos or videos. A button 1102 is presented within the effect window showing the live view that gives the user options to generate media content-for example, a short press of the button 1102 will capture a still photo, while a long press will record a video clip. This allows the user to easily create media content with the special effect applied.

Showing a live preview in the effect window 702 builds excitement and engagement by revealing the effect in action on the user's own camera feed. The integrated capture options enable instantly producing creations to save and share using the special effect, without needing to install separate apps or switch between services. Everything from special effect selection to media creation and sharing can occur directly within the web interface.

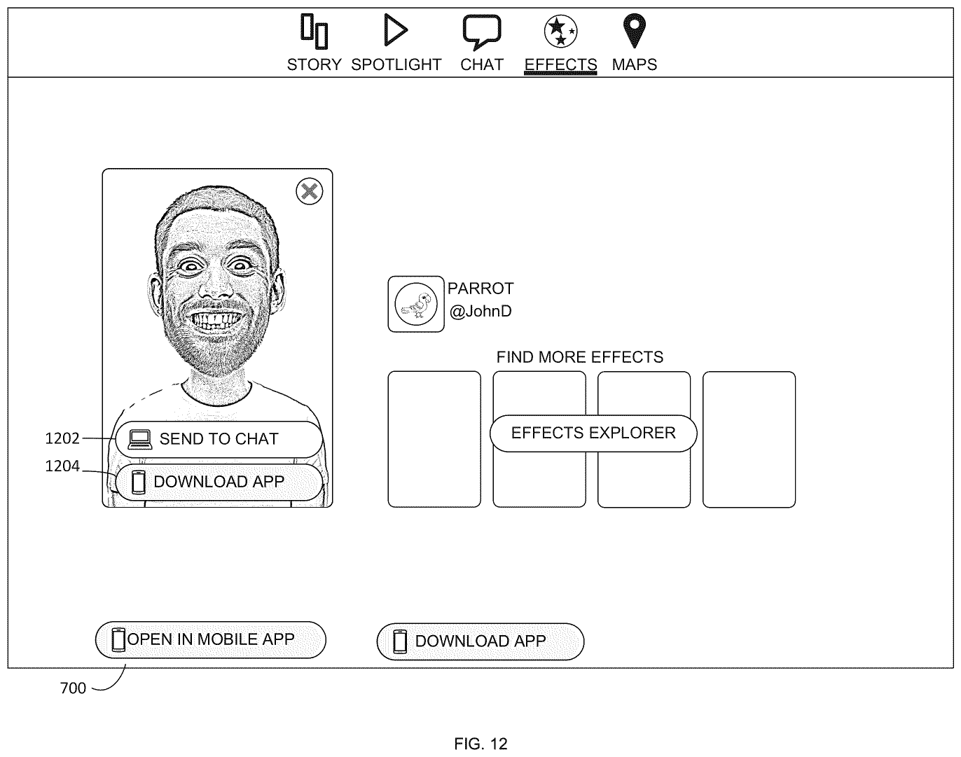

FIG. 12 illustrates an example interface 700 allowing the user to save and share media content after creating it using the special effect. The web page 700 includes options to “Send to Chat” 1202 which shares the image or video clip directly into a connected messaging platform. Alternatively, a “Download App” button 1204 allows the user to download a mobile app for the special effect service. For instance, if the user is currently using a mobile computing device (e.g., smart phone), the “Download App” button 1204 may link directly to the download page for the mobile app in the app store affiliated with the provider of the operating system. Alternatively, if the user is currently using another device (e.g., a laptop or desktop computer), selecting the “Download App” button 1204 may result in the presentation of a web page with a QR code that, when scanned with a camera of a mobile device, will cause presentation on the mobile device of link to the download page for the mobile app in the app store. Although not shown in FIG. 12, another button may be presented allowing the user to save the media content locally, or in a cloud-based file service.

Providing integrated sharing and saving capabilities allows the user to get full value from the creations produced using the special effect, without needing to juggle multiple apps or services. They can download the image or video clip to their camera roll or share it to connected social media accounts and messaging platforms with minimal friction. Streamlining the content creation and sharing process improves the overall user experience. Users can progress seamlessly from effect selection to media capture to sharing, all within one web interface. This provides a frictionless flow for producing and distributing engaging creations using the interactive special effects.

### Machine Architecture

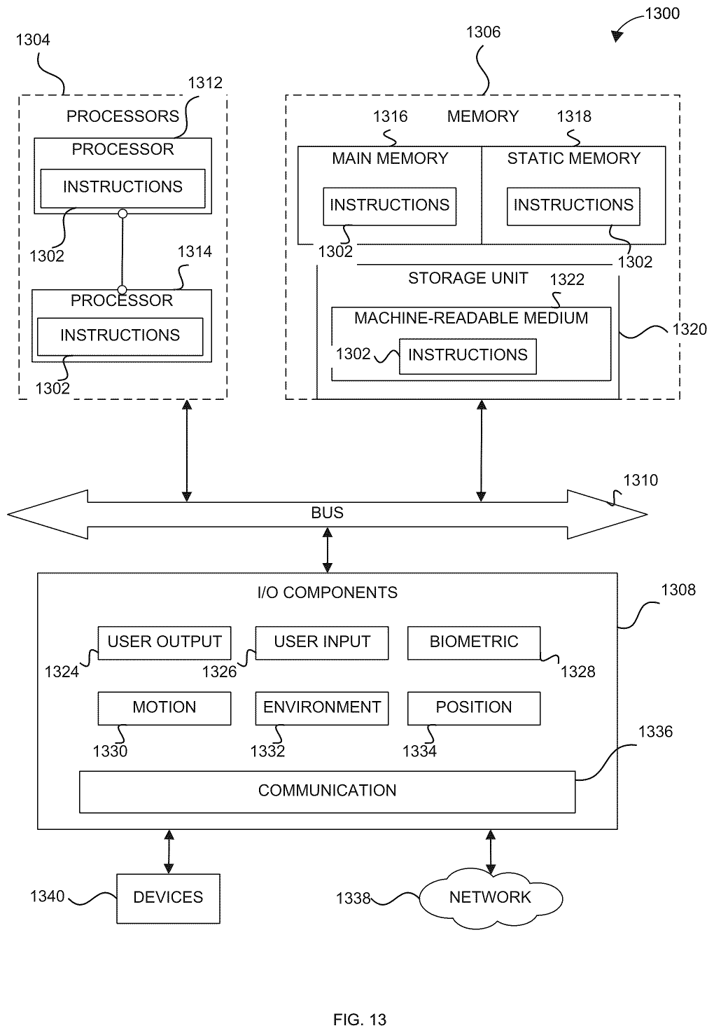

FIG. 13 is a diagrammatic representation of the machine 1300 within which instructions 1302 (e.g., software, a program, an application, an applet, an app, or other executable code) for causing the machine 1300 to perform any one or more of the methodologies discussed herein may be executed. For example, the instructions 1302 may cause the machine 1300 to execute any one or more of the methods described herein. The instructions 1302 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1302, sequentially or otherwise, that specify actions to be taken by the machine 1300. Further, while a single machine 1300 is illustrated, the term “machine” shall also be taken to include a collection of machines that individually or jointly execute the instructions 1302 to perform any one or more of the methodologies discussed herein. The machine 1300, for example, may comprise the user system 102 or any one of multiple server devices forming part of the interaction server system 110. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 1308, which may be configured to communicate with each other via a bus 1310. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1312 and a processor 1314 that execute the instructions 1302. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1316, a static memory 1318, and a storage unit 1320, both accessible to the processors 1304 via the bus 1310. The main memory 1306, the static memory 1318, and storage unit 1320 store the instructions 1302 embodying any one or more of the methodologies or functions described herein. The instructions 1302 may also reside, completely or partially, within the main memory 1316, within the static memory 1318, within machine-readable medium 1322 within the storage unit 1320, within at least one of the processors 1304 (e.g., within the processor's cache memory), or any suitable combination thereof, during execution thereof by the machine 1300.

The I/O components 1308 may include a wide variety of components to receive input, provide output, produce output, transmit information, exchange information, capture measurements, and so on. The specific I/O components 1308 that are included in a particular machine will depend on the type of machine. For example, portable machines such as mobile phones may include a touch input device or other such input mechanisms, while a headless server machine will likely not include such a touch input device. It will be appreciated that the I/O components 1308 may include many other components that are not shown in FIG. 13. In various examples, the I/O components 1308 may include user output components 1324 and user input components 1326. The user output components 1324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1308 may include biometric components 1328, motion components 1330, environmental components 1332, or position components 1334, among a wide array of other components. For example, the biometric components 1328 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1330 include acceleration sensor components (e.g., accelerometer), gravitation sensor components, rotation sensor components (e.g., gyroscope).

The environmental components 1332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1334 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1308 further include communication components 1336 operable to couple the machine 1300 to a network 1338 or devices 1340 via respective coupling or connections. For example, the communication components 1336 may include a network interface component or another suitable device to interface with the network 1338. In further examples, the communication components 1336 may include wired communication components, wireless communication components, cellular® communication components, Near Field Communication (NFC) components, Bluetooth components (e.g., Bluetooth® Low Energy), Wi-Fi® components, and other communication components to provide communication via other modalities. The devices 1340 may be another machine or any of a wide variety of peripheral devices (e.g., a peripheral device coupled via a USB).

Moreover, the communication components 1336 may detect identifiers or include components operable to detect identifiers. For example, the communication components 1336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1336, such as location via Internet Protocol (IP) geolocation, location via Wi-Fi® signal triangulation, location via detecting an NFC beacon signal that may indicate a particular location, and so forth.

The various memories (e.g., main memory 1316, static memory 1318, and memory of the processors 1304) and storage unit 1320 may store one or more sets of instructions and data structures (e.g., software) embodying or used by any one or more of the methodologies or functions described herein. These instructions (e.g., the instructions 1302), when executed by processors 1304, cause various operations to implement the disclosed examples.

The instructions 1302 may be transmitted or received over the network 1338, using a transmission medium, via a network interface device (e.g., a network interface component included in the communication components 1336) and using any one of several well-known transfer protocols (e.g., hypertext transfer protocol (HTTP)). Similarly, the instructions 1302 may be transmitted or received using a transmission medium via a coupling (e.g., a peer-to-peer coupling) to the devices 1340.

### Software Architecture

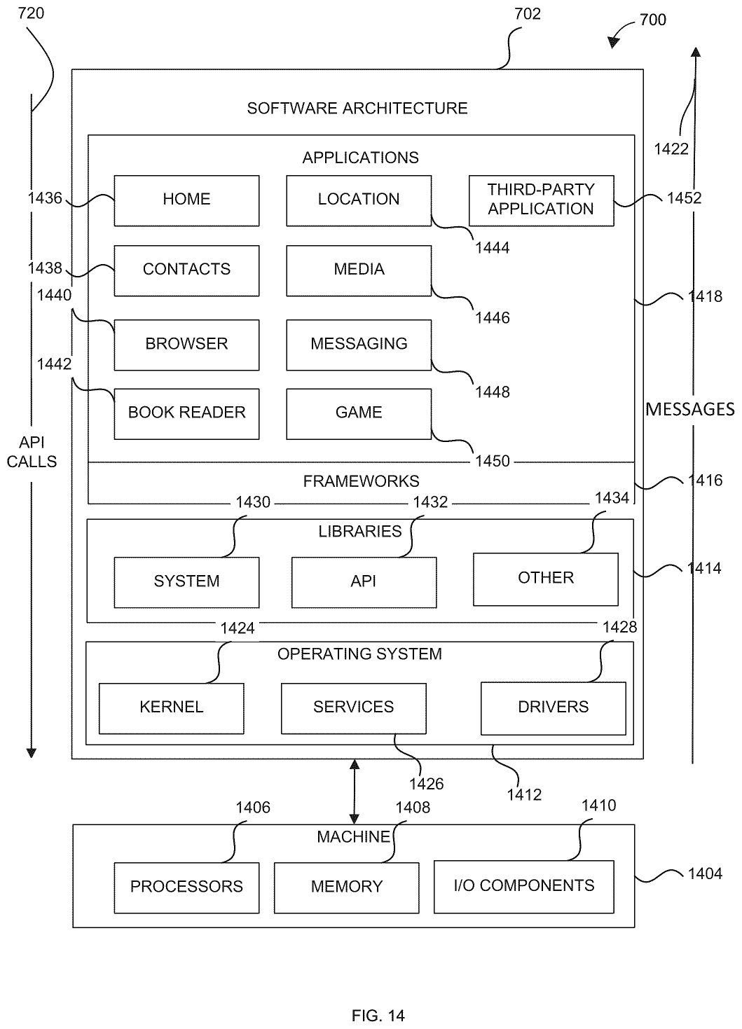

FIG. 14 is a block diagram 1400 illustrating a software architecture 1402, which can be installed on any one or more of the devices described herein. The software architecture 1402 is supported by hardware such as a machine 1404 that includes processors 1406, memory 1408, and I/O components 1410. In this example, the software architecture 1402 can be conceptualized as a stack of layers, where each layer provides a particular functionality. The software architecture 1402 includes layers such as an operating system 1412, libraries 1414, frameworks 1416, and applications 1418. Operationally, the applications 1418 invoke API calls 1420 through the software stack and receive messages 1422 in response to the API calls 1420.

The operating system 1412 manages hardware resources and provides common services. The operating system 1412 includes, for example, a kernel 1424, services 1426, and drivers 1428. The kernel 1424 acts as an abstraction layer between the hardware and the other software layers. For example, the kernel 1424 provides memory management, processor management (e.g., scheduling), component management, networking, and security settings, among other functionalities. The services 1426 can provide other common services for the other software layers. The drivers 1428 are responsible for controlling or interfacing with the underlying hardware. For instance, the drivers 1428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1414 provide a common low-level infrastructure used by the applications 1418. The libraries 1414 can include system libraries 1430 (e.g., C standard library) that provide functions such as memory allocation functions, string manipulation functions, mathematic functions, and the like. In addition, the libraries 1414 can include API libraries 1432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 1434 to provide many other APIs to the applications 1418.

The frameworks 1416 provide a common high-level infrastructure that is used by the applications 1418. For example, the frameworks 1416 provide various graphical user interface (GUI) functions, high-level resource management, and high-level location services. The frameworks 1416 can provide a broad spectrum of other APIs that can be used by the applications 1418, some of which may be specific to a particular operating system or platform.

In an example, the applications 1418 may include a home application 1436, a contacts application 1438, a browser application 1440, a book reader application 1442, a location application 1444, a media application 1446, a messaging application 1448, a game application 1450, and a broad assortment of other applications such as a third-party application 1452. The applications 1418 are programs that execute functions defined in the programs. Various programming languages can be employed to create one or more of the applications 1418, structured in a variety of manners, such as object-oriented programming languages (e.g., Objective-C, Java, or C++) or procedural programming languages (e.g., C or assembly language). In a specific example, the third-party application 1452 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1452 can invoke the API calls 1420 provided by the operating system 1412 to facilitate functionalities described herein.

### EXAMPLES

Example 1 is a computing device comprising: a processor; a memory storing instructions that, when executed by the processor, cause the computing device to perform operations comprising: displaying, by a web browser application executing on the computing device, a web page provided by a server, the web page including a selection of special effects; receiving, by the web browser, a user selection of a special effect from the selection of special effects; in response to the user selection, the web browser executing a script provided by the server to: access a camera of the client computing device; apply the selected special effect to a video stream received from the camera; render the video stream with the applied special effect in a display window within the displayed web page, thereby providing a live view of the special effect; receiving, by the web browser, a user capture input while providing the live view of the special effect; in response to receiving the user capture input, capturing image data or video data from the live view of the special effect; displaying, within the web page, a sharing option for sharing the captured image data or video data; receiving, by the web browser, a user selection of the sharing option; and in response to receiving the user selection of the sharing option, the web browser executing instructions for determining a native sharing application available on the client computing device and programmatically invoking the native sharing application to share the captured image data or video data.

In Example 2, the subject matter of Example 1 includes, wherein the selection of special effects comprises a plurality of selectable special effects, and wherein the operations further comprise: displaying a user interface element within the web page that, when selected, causes the web page to be refreshed to display a different special effect than the selected special effect.

In Example 3, the subject matter of Examples 1-2 includes, wherein the sharing option comprises a plurality of selectable sharing options, and wherein programmatically invoking the native sharing application comprises: determining a type of the captured image data or video data; determining a native sharing application associated with the type of the captured image data or video data; and programmatically invoking the determined native sharing application to share the captured image data or video data.

In Example 4, the subject matter of Examples 1-3 includes, wherein the operations further comprise: displaying, within the web page, a download option for downloading the captured image data or video data; receiving, by the web browser, a user selection of the download option; in response to receiving the user selection of the download option: determining whether the client computing device is a mobile device or a desktop device; when the computing device is determined to be a desktop device, displaying a code for scanning by a mobile device camera; and when the computing device is determined to be a mobile device, programmatically invoking an application store on the mobile device to install a native application associated with the web page.

In Example 5, the subject matter of Examples 1-4 includes, wherein the operations further comprise: displaying, within the web page, a preview option for previewing the captured image data or video data; receiving, by the web browser, a user selection of the preview option; in response to receiving the user selection of the preview option, displaying a preview of the captured image data or video data within the web page.

In Example 6, the subject matter of Example 5 includes, wherein displaying the preview comprises displaying the captured image data or video data with the special effect applied.

In Example 7, the subject matter of Examples 1-6 includes, wherein the script is JavaScript code configured to access the camera of the client computing device through a getUserMedia API call to a browser of the client computing device.

Example 8 is a computer-implemented method comprising: displaying, on a computing device via a web browser application, a web page provided by a server, wherein the web page includes, a selection of special effects; receiving, through the web browser, a user selection of a special effect from the selection of special effects; in response to the user selection, executing a script provided by the server to perform the following operations: accessing a camera of the computing device; applying the selected special effect to a video stream received from the camera; rendering the video stream with the applied special effect in a display window within the web page to provide a live view of the special effect; receiving, through the web browser, a user capture input while the live view of the special effect is provided; capturing, in response to the user capture input, image data or video data from the live view of the special effect; displaying, within the web page, a sharing option for the captured image data or video data; receiving, through the web browser, a user selection of the sharing option; and in response to the user selection of the sharing option, executing instructions for determining a native sharing application available on the computing device and programmatically invoking the native sharing application to share the captured image data or video data.

In Example 9, the subject matter of Example 8 includes, displaying a user interface element within the web page that, when selected by the user, causes the web page to be refreshed to display a different special effect from the previously selected special effect, wherein the selection of special effects comprises a plurality of selectable special effects.

In Example 10, the subject matter of Examples 8-9 includes, determining a type of the captured image data or video data; determining a native sharing application associated with the type of the captured image data or video data when the sharing option comprises a plurality of selectable sharing options; and programmatically invoking the determined native sharing application to share the captured image data or video data.

In Example 11, the subject matter of Examples 8-10 includes, displaying, within the web page, a download option for downloading the captured image data or video data; receiving, through the web browser, a user selection of the download option; and in response to receiving the user selection of the download option: determining whether the computing device is a mobile device or a desktop device; when the computing device is determined to be a desktop device, displaying a code for scanning by a mobile device camera; and when the computing device is determined to be a mobile device, programmatically invoking an application store on the mobile device to install a native application associated with the web page.

In Example 12, the subject matter of Examples 8-11 includes, displaying, within the web page, a preview option for previewing the captured image data or video data; receiving, through the web browser, a user selection of the preview option; and in response to receiving the user selection of the preview option, displaying a preview of the captured image data or video data within the web page.

In Example 13, the subject matter of Example 12 includes, displaying the captured image data or video data with the special effect applied.

In Example 14, the subject matter of Examples 8-13 includes, executing JavaScript code configured to access the camera of the computing device through a getUserMedia API call to the web browser.

Example 15 is a server comprising: one or more processors; a memory storing instructions that, when executed by the processor, cause the server to perform operations comprising: receiving an HTTP request from a client device; in response to the HTTP request, transmitting a web page to the client device for display in a web browser executing on the client device, the web page including a selection of special effects; receiving, from the web browser on the client device, a request for a script associated with a special effect selected from the selection of special effects; in response to receiving the request, transmitting the script to the web browser, wherein the script causes the web browser to: access a camera of the client device; apply the selected special effect to a video stream from the camera; render the video stream with the applied special effect in the web page, providing a live view of the special effect; receive a user capture input; in response to the user capture input, capture image data or video data of the live view; display a sharing option for sharing the captured image data or video data; receive a user selection of the sharing option; and in response to the user selection of the sharing option, invoke a native sharing application on the client device to share the captured image data or video data.

In Example 16, the subject matter of Example 15 includes, wherein the selection of special effects comprises a plurality of selectable special effects, and wherein the operations further comprise: receiving a request for a different script associated with a different special effect selected from the selection of special effects; in response to receiving the request, transmitting the different script to the web browser, wherein the different script causes the web browser to apply the different special effect.

In Example 17, the subject matter of Examples 15-16 includes, wherein the operations further comprise: receiving the captured image data or video data from the web browser; storing the received image data or video data; generating a link or identifier for accessing the stored image data or video data; and transmitting the link or identifier to the web browser.

In Example 18, the subject matter of Examples 15-17 includes, wherein the operations further comprise: providing, within the web page, an interface for the user to preview the live view of the special effect prior to capturing the image data or video data; receiving, from the web browser on the client device, a user input indicating a desire to preview the special effect; and in response to the user input, enabling a preview mode on the web browser where the user can interact with the live view of the special effect without capturing the image data or video data.

In Example 19, the subject matter of Example 18 includes, wherein the operations further comprise: detecting, via the script, a user gesture performed during the preview mode; in response to detecting the user gesture, modifying the live view of the special effect to include an interactive element that responds to the user gesture.

In Example 20, the subject matter of Examples 15-19 includes, wherein the operations further comprise: receiving, from the web browser on the client device, a request for additional information about the selected special effect; retrieving the additional information from a database in communication with the server; and transmitting the additional information to the web browser for display to the user, wherein the additional information includes at least one of: a description of the special effect, usage instructions, or user-generated content featuring the special effect.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A computing device comprising:
a processor;
a memory storing instructions that, when executed by the processor, cause the computing device to perform operations comprising:
displaying, by a web browser application executing on the computing device, a web page provided by a server, the web page including a selection of special effects;
receiving, by the web browser, a user selection of a special effect from the selection of special effects;
in response to the user selection, the web browser executing a script provided by the server to:
access a camera of the computing device;
apply the selected special effect to a video stream received from the camera;
render the video stream with the applied special effect in a display window within the displayed web page, thereby providing a live view of the special effect;
receiving, by the web browser, a user capture input while providing the live view of the special effect;
in response to receiving the user capture input, capturing image data or video data from the live view of the special effect;
displaying, within the web page, a sharing option for sharing the captured image data or video data;
receiving, by the web browser, a user selection of the sharing option; and
in response to receiving the user selection of the sharing option, the web browser executing instructions for determining a native sharing application available on the client computing device and
programmatically invoking the native sharing application to share the captured image data or video data.

2. The computing device of claim 1, wherein the selection of special effects comprises a plurality of selectable special effects, and wherein the operations further comprise:
displaying a user interface element within the web page that, when selected, causes the web page to be refreshed to display a different special effect than the selected special effect.

3. The computing device of claim 1, wherein the sharing option comprises a plurality of selectable sharing options, and wherein programmatically invoking the native sharing application comprises:
determining a type of the captured image data or video data;
determining a native sharing application associated with the type of the captured image data or video data; and
programmatically invoking the determined native sharing application to share the captured image data or video data.

4. The computing device of claim 1, wherein the operations further comprise:
displaying, within the web page, a download option for downloading the captured image data or video data;
receiving, by the web browser, a user selection of the download option;
in response to receiving the user selection of the download option:
determining whether the client computing device is a mobile device or a desktop device;
when the computing device is determined to be a desktop device, displaying a code for scanning by a mobile device camera; and
when the computing device is determined to be a mobile device, programmatically invoking an application store on the mobile device to install a native application associated with the web page.

5. The computing device of claim 1, wherein the operations further comprise:
displaying, within the web page, a preview option for previewing the captured image data or video data;
receiving, by the web browser, a user selection of the preview option;
in response to receiving the user selection of the preview option, displaying a preview of the captured image data or video data within the web page.

6. The computing device of claim 5, wherein displaying the preview comprises displaying the captured image data or video data with the special effect applied.

7. The computing device of claim 1, wherein the script is JavaScript code configured to access the camera of the client computing device through a getUserMedia API call to a browser of the client computing device.

8. A computer-implemented method comprising:
displaying, on a computing device via a web browser application, a web page provided by a server, wherein the web page includes a selection of special effects;
receiving, through the web browser, a user selection of a special effect from the selection of special effects;
in response to the user selection, executing a script provided by the server to perform the following operations:
accessing a camera of the computing device;
applying the selected special effect to a video stream received from the camera;
rendering the video stream with the applied special effect in a display window within the web page to provide a live view of the special effect;
receiving, through the web browser, a user capture input while the live view of the special effect is provided;
capturing, in response to the user capture input, image data or video data from the live view of the special effect;
displaying, within the web page, a sharing option for the captured image data or video data;
receiving, through the web browser, a user selection of the sharing option; and
in response to the user selection of the sharing option, executing instructions for determining a native sharing application available on the computing device and programmatically invoking the native sharing application to share the captured image data or video data.

9. The computer-implemented method of claim 8, further comprising:
displaying a user interface element within the web page that, when selected by the user, causes the web page to be refreshed to display a different special effect from the previously selected special effect, wherein the selection of special effects comprises a plurality of selectable special effects.

10. The computer-implemented method of claim 8, further comprising:
determining a type of the captured image data or video data;
determining a native sharing application associated with the type of the captured image data or video data when the sharing option comprises a plurality of selectable sharing options; and
programmatically invoking the determined native sharing application to share the captured image data or video data.

11. The computer-implemented method of claim 8, further comprising:
displaying, within the web page, a download option for downloading the captured image data or video data;
receiving, through the web browser, a user selection of the download option; and
in response to receiving the user selection of the download option:
determining whether the computing device is a mobile device or a desktop device;
when the computing device is determined to be a desktop device, displaying a code for scanning by a mobile device camera; and
when the computing device is determined to be a mobile device, programmatically invoking an application store on the mobile device to install a native application associated with the web page.

12. The computer-implemented method of claim 8, further comprising:
displaying, within the web page, a preview option for previewing the captured image data or video data;
receiving, through the web browser, a user selection of the preview option; and
in response to receiving the user selection of the preview option, displaying a preview of the captured image data or video data within the web page.

13. The computer-implemented method of claim 12, further comprising:
displaying the captured image data or video data with the special effect applied.

14. The computer-implemented method of claim 8, further comprising:
executing JavaScript code configured to access the camera of the computing device through a getUserMedia API call to the web browser.

15. A server comprising:
one or more processors;
a memory storing instructions that, when executed by the processor, cause the server to perform operations comprising:
receiving an HTTP request from a client device;
in response to the HTTP request, transmitting a web page to the client device for display in a web browser executing on the client device, the web page including a selection of special effects;
receiving, from the web browser on the client device, a request for a script associated with a special effect selected from the selection of special effects;
in response to receiving the request, transmitting the script to the web browser, wherein the script causes the web browser to:
access a camera of the client device;
apply the selected special effect to a video stream from the camera;
render the video stream with the applied special effect in the web page, providing a live view of the special effect;
receive a user capture input;
in response to the user capture input, capture image data or video data of the live view;
display a sharing option for sharing the captured image data or video data;
receive a user selection of the sharing option; and
in response to the user selection of the sharing option, invoke a native sharing application on the client device to share the captured image data or video data.

16. The server of claim 15, wherein the selection of special effects comprises a plurality of selectable special effects, and wherein the operations further comprise:
receiving a request for a different script associated with a different special effect selected from the selection of special effects;
in response to receiving the request, transmitting the different script to the web browser, wherein the different script causes the web browser to apply the different special effect.

17. The server of claim 15, wherein the operations further comprise:
receiving the captured image data or video data from the web browser;
storing the received image data or video data;
generating a link or identifier for accessing the stored image data or video data; and
transmitting the link or identifier to the web browser.

18. The server of claim 15, wherein the operations further comprise:
providing, within the web page, an interface for the user to preview the live view of the special effect prior to capturing the image data or video data;
receiving, from the web browser on the client device, a user input indicating a desire to preview the special effect; and
in response to the user input, enabling a preview mode on the web browser where the user can interact with the live view of the special effect without capturing the image data or video data.

19. The server of claim 18, wherein the operations further comprise:
detecting, via the script, a user gesture performed during the preview mode;
in response to detecting the user gesture, modifying the live view of the special effect to include an interactive element that responds to the user gesture.

20. The server of claim 15, wherein the operations further comprise:
receiving, from the web browser on the client device, a request for additional information about the selected special effect;
retrieving the additional information from a database in communication with the server; and
transmitting the additional information to the web browser for display to the user, wherein the additional information includes at least one of: a description of the special effect, usage instructions, or user-generated content featuring the special effect.
